(19) United States
(12) Patent Application Publication
(10) Pub. No.: US 2016/0176514 A1
(43) Pub. Date: Jun. 23, 2016

(54) ROTARY WING DRONE

(71) Applicant: PARROT, Paris (FR)

(72) Inventors: Gauthier Lavagen, Paris (FR); Karim Fargeau, Charenton Le Pont (FR); Yoni Benatar, Les Lilas (FR)

(21) Appl. No.: 14/957,080

(22) Filed: Dec. 2, 2015

(30) Foreign Application Priority Data
Dec. 22, 2014 (FR) 14 63075

(51) Int. Cl. B64C 25/36; B64C 37/00; A63H 23/14; A63H 27/00; A63H 17/26; B64C 39/02; B64C 25/54

(52) U.S. Cl. CPC B64C 25/36; B64C 39/024; B64C 37/00; B64C 25/54; A63H 27/12; A63H 17/26; A63H 23/14; B64C 2201/126; B64C 2201/108; B64C 2201/024

(57) ABSTRACT

The drone comprises a body and a plurality of propulsion units, each provided with a propeller driven by a respective motor, the different motors being able to be controlled in a differentiated manner so as to pilot the drone in attitude and speed and with production of a lifting force. The accessory has a shaft that is removably fastened to the drone body in a transverse orientation with respect to the main direction of progression of the drone, and at a point located in alignment with the center of gravity of the drone and above that center of gravity. The accessory has two ring elements that are mounted freely in rotation, independently of each other, at the ends of the shaft and symmetrically with respect to the drone body. The density of these ring elements with respect to water is lower than the unit, and their diameter is higher than the overall size of the drone.

### FIELD OF DISCLOSURE

The invention relates to the leisure drones, in particular the rotary-wing drones such as quadricopters and the like.

### BACKGROUND

Such drones comprise a drone body and a plurality of propulsion units mounted at the end of connection arms, each propulsion unit being provided with a propeller driven by a respective motor. The different motors can be controlled in a differentiated manner so as to pilot the drone in attitude and speed.

Such an example is the Rolling Spider marketed by Parrot SA, Paris, France.

This drone may in particular be provided with an accessory consisted of a shaft provided at each of its ends with a wheel of great diameter. The shaft is oriented transversely with respect to the main direction of evolution of the drone and the wheels have a diameter higher than the maximum overall size of the drone with its propellers. This configuration allows in particular not only to make the drone fly but also, provided with its wheels, to make this drone roll on the ground, along a wall, against a ceiling, etc., hence multiplying the possibilities of evolution, in addition to the usual configurations of free flight and lift of the drone.

The US 2014/131507 A1 also describes a drone of a comparable type, surrounded with an external cage freely mobile in rotation, which allows the drone to roll on the ground or against a wall.

The object of the invention is to propose an accessory allowing such a drone to evolve not only in free flight and on the ground or against a wall, but also on a stretch of water.

In other words, the matter is, with a single accessory, to make the drone fully amphibian by its own means, with multiple abilities of evolution “air-earth-sea”, according to only the commands sent by the user.

A light-weight floating structure such as a sailing boat may be made amphibian by being added with four wheels allowing it to also move across ground, as described in the WO 2004/094226 A2. The wheels may be wheels also acting as floats, to increase the buoyancy of the structure.

To make a conventional aircraft amphibian (as in the case of hydroplanes or certain helicopters), the flying structure is provided with floats, and possibly a suitable hull, allowing it to land on a stretch of water and to move across the latter in particular during the take-off and landing phases. The drawback of the floats is however their significant drag, which very strongly brake the aircraft.

This phenomenon does not interfere with landing/take-off phases, because at take-off the acceleration of the aircraft produces a rapid lift-off reducing the drag, and at landing the resistance offered by the floats facilitates the slowing down to stopping.

On the contrary, if the matter is only to move across the stretch of water out of landing/take-off phases, the hydrodynamic reaction of the floats to the progression is a real drawback.

It is the same when it is desired to perform rapid manoeuvres such as U-turns or other changes of orientation, which cannot be performed on the spot but require a free space around the aircraft, to allow the latter the carry out a bend while continuing to float.

The object of the invention is to solve the abovementioned problems, by proposing an accessory allowing the drone to move in a similar way on the ground or against a wall, on a stretch of water or in the air with no change of accessory, with abilities of evolution on water comparable to those met on a firm ground, i.e.:

small resistance to progress;

immediate changes of direction, with no bend, with typically rotation of a quarter of a turn or a U-turn on the spot;

free-standing character of the unit when stopped, i.e. no propulsion is required to ensure the buoyancy and the good orientation of the drone.

The invention proposes for that purpose a rotary-wing drone comprising in a manner known per se (for example, as the Rolling Spider device mentioned and described hereinabove): a drone body; a plurality of propulsion units mounted at the end of connection arms, each propulsion unit being provided with a propeller driven by a respective motor and the different motors being able to be controlled in a differentiated manner so as to pilot the drone in attitude and speed and with production of a lifting force; and a drone accessory, comprising a shaft adapted to be removably fastened to the drone body in a transverse orientation with respect to the main direction of progression of the drone, and at a point located in alignment with the centre of gravity of the drone and above this centre of gravity.

Characteristically, the accessory comprises two ring elements mounted freely in rotation, independently of each other, at the respective ends of the shaft and symmetrically with respect to the drone body, and the density of these ring elements with respect to water is lower than the unit, and their diameter is higher than the overall size of the drone.

In an advantageous embodiment, each ring element is a solid element, made of an expanded plastic material, for example a material over-molded on a spoke wheel adapted to be rotationally mounted on the shaft.

### BRIEF DESCRIPTION OF THE DRAWINGS

An exemplary embodiment of the invention will now be described, with reference to the appended drawings in which the same references denote identical or functionally similar elements throughout the figures.

FIG. 1 is an overall view, in perspective, of a drone provided with an accessory according to the invention, allowing it to move in similar ways on the ground, on water, and in the air.

FIG. 2 is a sectional view along a vertical axial plane of the mobile part of the accessory, mounted at the end of the shaft on which it turns.

FIGS. 3(a) and (b) are front views of the drone of FIG. 1 in a configuration in which it is on a stretch of water, at rest with the propellers stopped and with a propulsion to allow it to progress on the stretch of water, respectively.

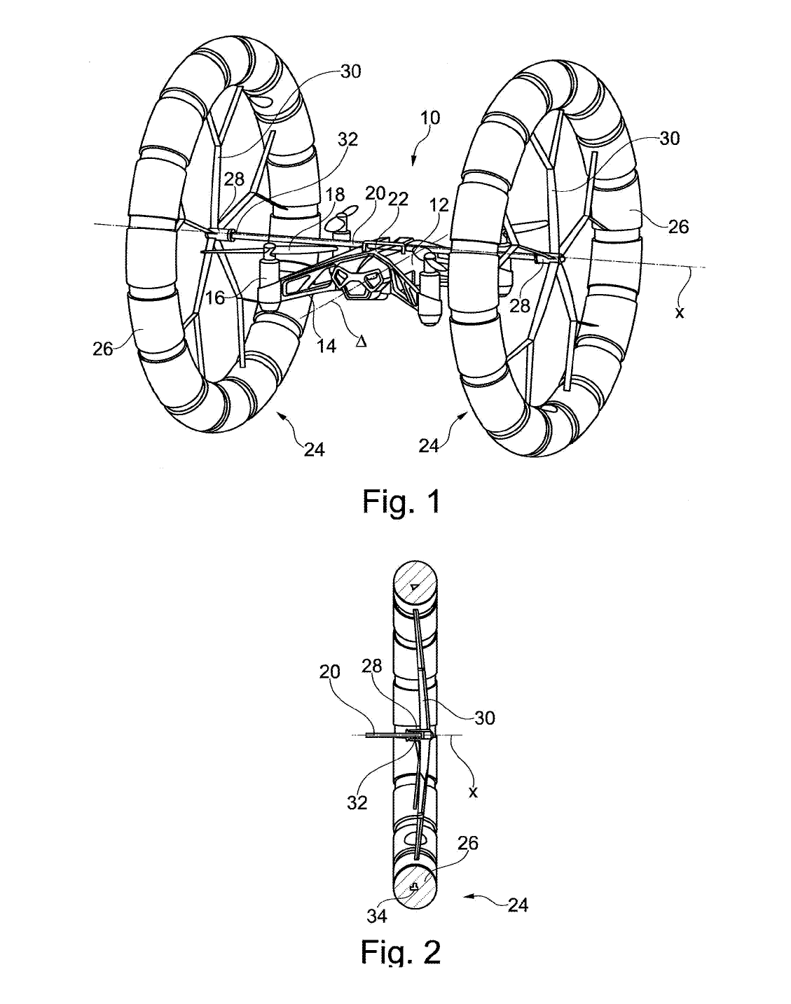

In FIG. 1 is shown a unit comprising a drone 10 of the quadricopter type, such as for example the Rolling Spider marketed by Parrot SA, Paris, France, with a central body 12 from which radiate four support arms 14. Each support arm 14 is equipped at its distal end with a propulsion unit 16 comprising a motor driving into rotation a propeller 18 extending in a horizontal plane above the support arm 14.

The drone is provided with an accessory carried by a transverse shaft 20 extending following an axis X perpendicular to the main direction Δ of movement of the drone. The shaft 20 is mounted on the drone body 12 by means of a connection part 22 enabling a user to easily detach the accessory from the drone, or conversely, to mount the accessory on the drone through a rapid fastening and locking system, such as for example that described in the application FR 14 56589 of Aug. 7, 2014, entitled “Système de fixation rapide d'un accessoire sur le corps d'un drone”.

The shaft 20 is mounted on the drone body 12 so as to be integral with the latter in translation and in rotation, i.e. the shaft 20 cannot move axially nor rotate about itself.

The shaft carries at each of its ends a mobile part 24, the two mobile parts 24 being mounted symmetrically with respect to the drone, on either side of the drone body 12 and of the propulsion units 16 and of the propellers 18. The mobile parts 24 extend in planes parallel to each other and perpendicular to the axis X of the shaft 20, and their external diameter is higher than the overall size of the drone with its propellers.

The mobile parts 24 carry at their periphery a ring element 26 connected to a hub 28 through radiating arms 30. These mobile parts 24 are mounted freely in rotation at the ends 32 of the shaft 20, each of the two parts 24 being able to turn independently of each other and being that way purely passive.

On the other hand, the density of the ring element 26 with respect to water is lower than the unit. Advantageously, as illustrated in FIG. 2, the ring element 26 is a solid element, made of an expanded plastic material such as PPE, over-molded on a circular wheel 34 integral with the radiating arms 30.

The mobile parts 24, which have no driving role, play a triple role:

in a configuration of flight, where the drone moves in the air, they protect the drone, and in particular its propellers, against shocks;

in a configuration of rolling on the ground or against a wall, they allow the drone to remain in contact with the ground or the wall but remote from it, the drone (driven by the only force of its propellers) being then able to roll on this ground or this wall;

in a configuration of moving on a stretch of water, they act as floats and allow the progression with the minimum of resistance of the drone at the surface of the stretch of water, characteristically of the invention and as will be explained hereinafter.

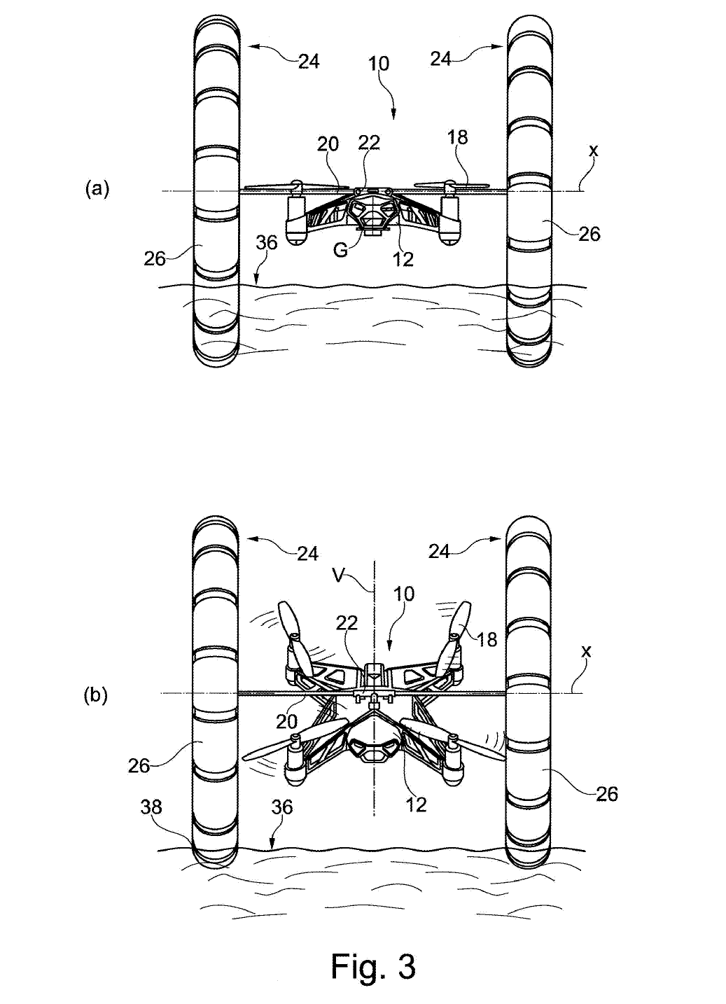

FIGS. 3(a) and (b) are front views of the drone equipped with its accessory, in a configuration where it is on a stretch of water, at rest with the propellers stopped (FIGS. 3(a)), and with a propulsion to allow it to progress on the stretch of water (FIG. 3(b)), respectively.

In the absence of propulsion, i.e. with the propellers 18 stopped (the configuration illustrated in FIG. 3(a)), the parts 24 play a simple role of floats, allowing to support the drone above the level of the stretch of water 36.

It will be noted that the shaft 20 is advantageously mounted on the back of the drone so that the centre of gravity G of the latter is located under the axis X of the shaft 20, which makes the system free-standing and allows a natural return to the equilibrium, with the drone horizontal, whatever the initial conditions.

It is hence possible to “throw into water” the drone provided with its accessory with no particular precaution, and the unit will always end in the position illustrated in FIG. 3a—which would not be the case with simple floats of the “hydroplane” type mounted on the drone, where the latter might fall on the stretch of water on its side or on its back, with no possibility to come back to the normal equilibrium position.

When the propellers are activated (the configuration illustrated in FIG. 3(b)), the drone, driven by the only force of its propellers, may move on the stretch of water 34. The mobile parts 24, which have only a passive role, ensure first the buoyancy of the unit on the stretch of water 36 thanks to the ring elements 26, with a small resistance to progression (far lower than that of conventional floats), due to the driving into rotation of the mobile parts 24.

It will be noted that the buoyancy is then essentially that of the air, due to the lifting force of the propellers of the drone that causes a lift-off of the ring elements 26, with a significant lowering of the water line 38, which reduces accordingly the resistance to progression on the stretch of water.

Moreover, all the movements possible on the ground are available on the stretch of water, in particular the possibility to carry out on the spot a U-turn or a quarter of a turn (rotation of the drone about a vertical axis V) through a differential control of the right and left propellers, the two mobile parts 24 then turning in reverse direction during this rotation on the spot.

Moreover, all the evolutions possible on the ground are available on the stretch of water, in particular the possibility to carry out on the spot a U-turn or a quarter of a turn (rotation of the drone about a vertical axis V) through a differential control of the right and left propellers, the two mobile parts 24 then turning in reverse direction during this rotation on the spot.

Moreover, it will noted that the piloting commands for an evolution of the drone rolling on the ground are perfectly compatible with a piloting of the drone on a stretch of water, and require no specific modification of the drone control software, nor of the user interface.

1. A rotary-wing drone, comprising:
a drone body;
a plurality of separately driven propellers that are mounted on in laterally offset arrangement on the drone body, enabling piloting of the drone in attitude and speed and with a lifting force;
a drone accessory that comprises a shaft that fastens to the drone body in a transverse orientation with respect to the main direction of movement of the drone, aligned with and above the center of gravity of the drone; and
two ring elements on the drone accessory that freely rotate, independently of each other, at respective ends of the shaft and symmetrically with respect to the drone body; the density of the ring elements being lower than the density of water and lower than the density of the drone body, and the diameter of the ring elements being greater than both the length and height of the drone body.

2. A rotary-wing drone, comprising:
a drone body;
a plurality of propulsion units mounted on the end of connection arms, each propulsion unit being provided with a propeller that is driven by a respective motor, the motors being controlled in a differentiated manner so as to pilot the drone in attitude and speed and with production of a lifting force; and
a drone accessory, comprising a shaft that is adapted to be removably fastened to the drone body in a transverse orientation with respect to the main direction of movement of the drone, and aligned with the center of gravity of the drone and above the center of gravity, characterized in that the accessory comprises two ring elements that are mounted freely in rotation, independently of each other, at respective ends of the shaft and symmetrically with respect to the drone body; and
in that the density of the ring elements with respect to water is lower than the unit, and the diameter of the ring elements is higher than the overall size of the drone body.

3. The drone of claim 2, wherein each ring element is a solid element, made of an expanded plastic material.

4. The drone of claim 3, wherein the expanded plastic material is a material over-moulded on a spoke wheel (34) adapted to be rotationally mounted on the shaft.
